(19) United States
(12) Patent Application Publication
(10) Pub. No.: US 2016/0246417 A1
(43) Pub. Date: Aug. 25, 2016

(54) In-Cell Touch Panel and Display Device

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yingming LIU, Beijing (CN); Xue DONG, Beijing (CN); Haisheng WANG, Beijing (CN); Xiaoliang DING, Beijing (CN); Shengji YANG, Beijing (CN)

(21) Appl. No.: 14/443,437

(22) PCT Filed: Sep. 28, 2014
(86) PCT No.: PCT/CN2014/087670

§ 371 Date: May 18, 2015

(30) Foreign Application Priority Data
Jun. 20, 2014 (CN) 201410281369.4

(51) Int. Cl. G06F 3/041; G02F 1/1362; G02F 1/1335; G02F 1/1333

(52) U.S. Cl. CPC G06F 3/0412; G02F 1/13338; G02F 1/136204; G02F 1/133514; G02F 1/133528; G06F 2203/04107

(57) ABSTRACT

The present invention provides an in-cell touch panel and a display device comprising the in-cell touch panel. The in-cell touch panel comprises an array substrate and a color filter substrate which are aligned and assembled with each other to form a cell, touch electrodes are provided between the array substrate and the color filter substrate, the in-cell touch panel further comprises an electrostatic releasing layer provided at a side of the color filter substrate away from the array substrate, wherein the electrostatic releasing layer is a transparent conductive layer with a square resistance of Meg-ohm level or more.

### FIELD OF THE INVENTION

The present invention relates to the field of display technology, and particularly relates to an in-cell touch panel and a display device.

### BACKGROUND OF THE INVENTION

Since an in-cell touch panel can make a display screen with touch function become lighter and thinner, the in-cell touch panel is more and more widely used in application of display device.

For example, an ADvanced super dimension switch (ADS) in-cell touch panel generally has a touch driving electrode (TX) and a touch sensing electrode (RX) provided within a liquid crystal cell formed by aligning and assembling an array substrate and a color filter substrate. Specifically, a common electrode layer provided on the array substrate is divided into two parts, wherein one part is used as a common electrode, and the other part is multiplexed as the touch driving electrode (TX) during a touch, the touch sensing electrode (RX) is provided in a transverse/longitudinal region of a black matrix at a position in the color filter substrate corresponding to the common electrode.

In order to avoid external electrostatic, the ADS in-cell touch panel is generally provided a conductive coating on an outer surface of the color filter substrate subjected to assembling with the array substrate, and the conductive coating is connected with ground of the touch panel to release electrostatic.

Currently, the conductive coating is generally made of indium tin oxide (ITO). In an aspect, the ITO material is a transparent material and will not influence on normal display of the touch panel. In another aspect, the ITO material has a good conductive property and can release electrostatic to ground well. However, since the ITO material has a good conductive property, touch signals may be shielded, so that the touch function of the touch panel cannot work properly, which may seriously affect the touch function of the touch panel to be achieved.

### SUMMARY OF THE INVENTION

In view of the above defects existing in the prior art, the present invention provides an in-cell touch panel and a display device comprising the in-cell touch panel. The in-cell touch panel is provided with a transparent electrostatic releasing layer having a square resistance above Meg-ohm (MΩ) level so that the touch panel is capable of releasing electrostatic well without shielding touch signals for the touch panel, thus influence and damage caused by static electricity to the touch panel may be avoided well, and touch-display function of the touch panel can be normally achieved.

The present invention provides an in-cell touch panel comprising an array substrate and a color filter substrate which are aligned and assembled with each other to form a cell, touch electrodes are provided between the array substrate and the color filter substrate, the in-cell touch panel further comprises an electrostatic releasing layer provided at a side of the color filter substrate away from the array substrate, wherein the electrostatic releasing layer is a transparent conductive layer with a square resistance of Meg-ohm level or more.

Preferably, the square resistance of the electrostatic releasing layer is greater than or equal to 1 MΩ and is less than or equal to 1 kMΩ.

Preferably, the in-cell touch panel further comprises a conductive shell and a ground terminal, the conductive shell covers at least one outer side of the in-cell touch panel except a touch-display surface, the ground terminal is used for connecting static electricity accumulated on the electrostatic releasing layer to ground; the ground terminal is provided on the array substrate and is electrically connected with the electrostatic releasing layer; or, the ground terminal is provided on the conductive shell and the electrostatic releasing layer is electrically connected with the conductive shell; or, the ground terminal includes a first ground terminal and a second ground terminal, the first ground terminal is provided on the array substrate, the second ground terminal is provided on the conductive shell, the first ground terminal is electrically connected with the electrostatic releasing layer, and the first ground terminal is electrically connected with the second ground terminal.

Preferably, the in-cell touch panel further comprises a cover plate and an upper polarizer, the cover plate is used for covering the touch-display surface of the in-cell touch panel; the upper polarizer is provided at a side of the color filter substrate away from the array substrate.

Preferably, the electrostatic releasing layer is made of insulation optical adhesive material, the insulation optical adhesive material is doped with conductive particles therein, and the conductive particles are uniformly distributed in the insulation optical adhesive.

Preferably, the upper polarizer and the electrostatic releasing layer are successively stacked on the color filter substrate, the cover plate covers the electrostatic releasing layer, and the electrostatic releasing layer also has a bonding effect.

Preferably, the in-cell touch panel further comprises a bonding layer, wherein the electrostatic releasing layer, the upper polarizer and the bonding layer are successively stacked on the color filter substrate, and the cover plate covers the bonding layer.

Preferably, the in-cell touch panel further comprises a bonding layer, wherein the upper polarizer, the bonding layer and the electrostatic releasing layer are successively stacked on the color filter substrate, and the cover plate covers the electrostatic releasing layer.

Preferably, an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

Preferably, the conductive ink has a thickness in a range of 50 μm-100 μm, a width in a range of 0.1 mm-0.5 mm, and a square resistance that is less than or equal to 1 kΩ.

Preferably, when the ground terminal is provided on the array substrate, the electrostatic releasing layer is electrically connected to the ground terminal through the conductive ink, and the conductive ink is electrically connected to the ground terminal through conductive silver paste and/or conductive adhesive tape; or, when the ground terminal is provided on the conductive shell, the electrostatic releasing layer is electrically connected to the conductive shell through the conductive ink, and the conductive ink is electrically connected to the ground terminal through conductive silver paste; or, when the ground terminal includes the first ground terminal and the second ground terminal, the first ground terminal is provided on the array substrate, the second ground terminal is provided on the conductive shell and the first ground terminal is electrically connected with the second ground terminal, the electrostatic releasing layer is electrically connected to the first ground terminal through the conductive ink, and the conductive ink is electrically connected to the first ground terminal through conductive silver paste and/or conductive adhesive tape; wherein, the conductive silver paste and the conductive adhesive tape are provided in the edge region of the in-cell touch panel corresponding to the non-touch-display region.

The present invention also provides a display device comprising above in-cell touch panel.

In the in-cell touch panel of the present invention, by providing the transparent electrostatic releasing layer with a square resistance of Meg-ohm level or more, the touch panel is capable of releasing electrostatic well without shielding touch signals for the touch panel, thus influence and damage caused by static electricity to the touch panel may be avoided well and touch-display function of the touch panel can be normally achieved. In the display device of the present invention, by using the above in-cell touch panel, influence and damage caused by static electricity to the touch panel may be avoided well and touch-display function of the touch panel can be normally achieved.

### BRIEF DESCRIPTION OF THE DRAWINGS

FIG. 1 is a structural section view of an in-cell touch panel in a first embodiment of the present invention.

FIG. 2 is a section view of another ground connection for the electrostatic releasing layer in the in-cell touch panel shown in FIG. 1.

FIG. 3 is a section view of still another ground connection for the electrostatic releasing layer in the in-cell touch panel shown in FIG. 1.

FIG. 4 is a structural section view of an in-cell touch panel in a second embodiment of the present invention.

FIG. 5 is a structural section view of an in-cell touch panel in a third embodiment of the present invention.

FIG. 6 is a structural section view of an in-cell touch panel in a fourth embodiment of the present invention.

### DETAILED DESCRIPTION OF THE EMBODIMENTS

In order that those skilled in the art can better understand the technical solutions of the present invention, a further detailed description of an in-cell touch panel and a display device of the present invention will be given below in conjunction with the accompanying drawings and specific implementations.

### First Embodiment

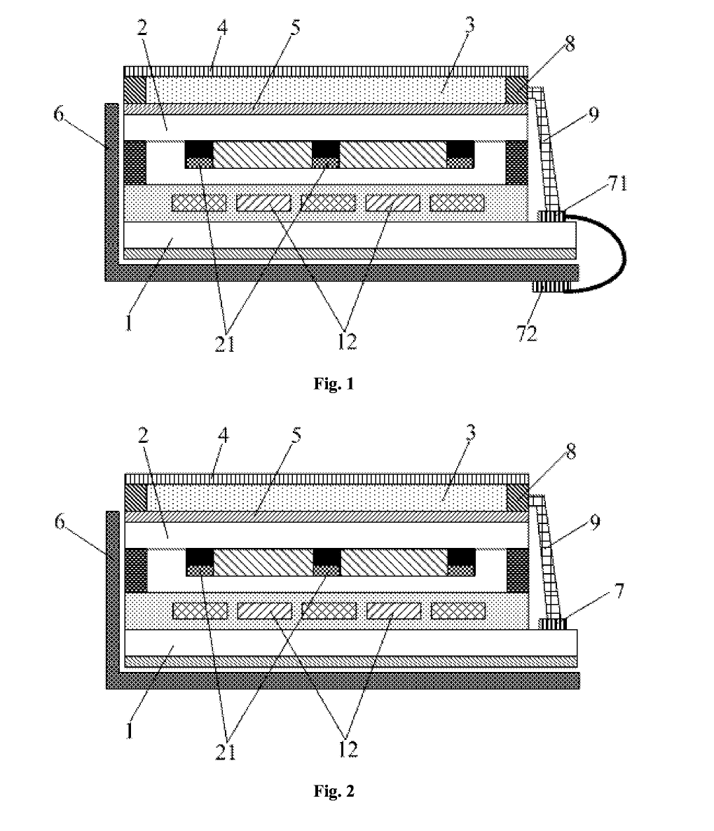

The present embodiment provides an in-cell touch panel. As shown in FIG. 1, the in-cell touch panel comprises an array substrate 1 and a color filter substrate 2 which are aligned and assembled with each other to form a cell, touch electrodes (i.e., touch driving electrode 12 and touch sensing electrode 21) are provided between the array substrate 1 and the color filter substrate 2, the in-cell touch panel further comprises an electrostatic releasing layer 3 provided at a side of the color filter substrate 2 away from the array substrate 1, wherein the electrostatic releasing layer 3 is a transparent conductive layer with a square resistance of Meg-ohm level or more.

The square resistance of the electrostatic releasing layer 3 may be greater than or equal to 1 MΩ and less than or equal to 1 kMΩ. The electrostatic releasing layer 3 with such a square resistance is capable of releasing electrostatic well without shielding touch signals for the touch panel, thus influence or damage caused by static electricity to the touch panel may be avoided well and touch-display function of the touch panel can be normally achieved.

In the present embodiment, the in-cell touch panel further comprises a cover plate 4 and an upper polarizer 5, the cover plate 4 is used for covering the touch-display surface of the in-cell touch panel, the upper polarizer 5 is provided at a side of the color filter substrate 2 away from the array substrate 1, and is used for processing light outgoing from the color filter substrate 2.

The electrostatic releasing layer 3 may be made of insulation optical adhesive material, the insulation optical adhesive material is doped with conductive particles therein, and the conductive particles are uniformly distributed in the insulation optical adhesive material, wherein the conductive particles in the insulation optical adhesive are bonded by molecules or chemical bonds, so that static electricity accumulated on the electrostatic releasing layer 3 can be conducted out. In addition, the upper polarizer 5 and the electrostatic releasing layer 3 may be successively stacked on the color filter substrate 2, the cover plate 4 covers the electrostatic releasing layer 3, and the electrostatic releasing layer 3 also has a bonding effect.

In the present embodiment, an edge region on a side of the cover plate 4 towards the color filter substrate 2, which corresponds to a non-touch-display region of the in-cell touch panel, is provided with conductive ink 8 therein, the conductive ink 8 is provided in periphery of the electrostatic releasing layer 3 and is connected with the electrostatic releasing layer 3, that is, the conductive ink 8 is in a ring shape and is provided in a non-touch-display region of the in-cell touch panel, the conductive ink is provided in such manner so that touch signals within the touch-display region of the in-cell touch panel will not be shielded. Moreover, since the electrostatic releasing layer 3 is made of material with high square resistance, it has low conductivity mobility (i.e., charge mobility), but the conductive ink 8 can effectively increase entire conductivity of the electrostatic releasing layer 3.

During procedure of forming the above electrostatic releasing layer 3, the material with high square resistance to be used for the electrical releasing layer 3 is generally first prepared, then the material is dropped on the color filter substrate 2, finally the cover plate 4 and the color filter substrate 2 are attached, during the procedure of attaching, the cover plate 4 and the color filter substrate 2 will squeeze the material with high square resistance so that the material with high square resistance is uniformly distributed between the cover plate 4 and the color filter substrate 2 to form the electrostatic releasing layer 3. Therefore, the conductive ink 8 also can effectively avoid overflow phenomenon of the electrostatic release layer 3 during procedure of attaching of the cover plate 4 and the color filter substrate 2, yield of attaching of the cover plate 4 and the color filter substrate 2 is improved. In addition, the conductive ink 8 also can make thicknesses of edge and center part of the touch panel uniform, touch-display performance of the touch panel is improved.

For example, the conductive ink 8 may have a thickness in a range of 50 μm-100 μm, a width in a range of 0.1 mm-0.5 mm, and a square resistance that is less than or equal to 1 kΩ.

In the present embodiment, the in-cell touch panel further comprises a conductive shell 6 and a ground terminal 7, the conductive shell 6 covers at least one outer side of the in-cell touch panel except a touch-display surface, the ground terminal is used for connecting static electricity accumulated on the electrostatic releasing layer 3 to ground, the ground terminal 7 may include a first ground terminal 71 and a second ground terminal 72, the first ground terminal 71 is provided on the array substrate 1, the second ground terminal 72 is provided on the conductive shell 6, the electrostatic releasing layer 3 is connected to the first ground terminal 71 through the conductive ink 8, and the first ground terminal 71 is electrically connected with the second ground terminal 72 through a conductive line.

For example, the conductive shell 6 may be a groove type shell which is capable of covering all outer sides of the touch panel except the touch-display surface. Since the conductive shell 6 is generally made of metal material and has a large surface area, it has good charge carrying capacity and charge conduction ability, the charge mobility thereof is relatively high, thus static electricity electrostatic accumulated on the electrostatic releasing layer 3 can be more rapidly and completely released.

In the present embodiment, the first ground terminal 71 is connected with the conductive ink 8 through the conductive silver paste 9, so that the first ground terminal 71 is electrically connected with the electrostatic releasing layer 3, the conductive silver paste 9 is provided in the edge region corresponding to the non-touch-display region of the in-cell touch panel, thus the conductive silver paste 9 provided in such manner will not shield touch signals in the touch-display region of the touch panel, and will not have any impact on display of the touch panel. Generally, a professional silver paste point connecting device is used for placing one drop of liquid conductive silver paste 9 respectively onto corresponding connection points of the first ground terminal 71 and the conductive ink 8, the two drops of liquid conductive silver paste 9 diffuse along edge regions of substrates (for example, the color filter substrate and the array substrate) of the in-cell touch panel, connect with each other, and finally solidify into solid, so that the first ground terminal 71 is electrically connected with the conductive ink 8 through the solidified conductive silver paste 9, thereby the first ground terminal 71 is connected with the electrostatic releasing layer 3. The conductive silver paste 9 shown in FIG. 1 only schematically shows the location thereof, and does not represent the actual structure thereof.

In accordance with above configuration of the touch panel, when static electricity is accumulated on the electrostatic releasing layer 3, the static electricity can be conducted and released through a path along the electrostatic releasing layer 3, the conductive ink 8, the conductive silver paste 9, the first ground terminal 71 and the second ground terminal 72, so that influence on the touch panel caused by static electricity can be effectively avoided, wherein the second ground terminal 72 is generally connected with a ground line of a peripheral circuit, so that the static electricity is conducted to ground through the ground line of the peripheral circuit.

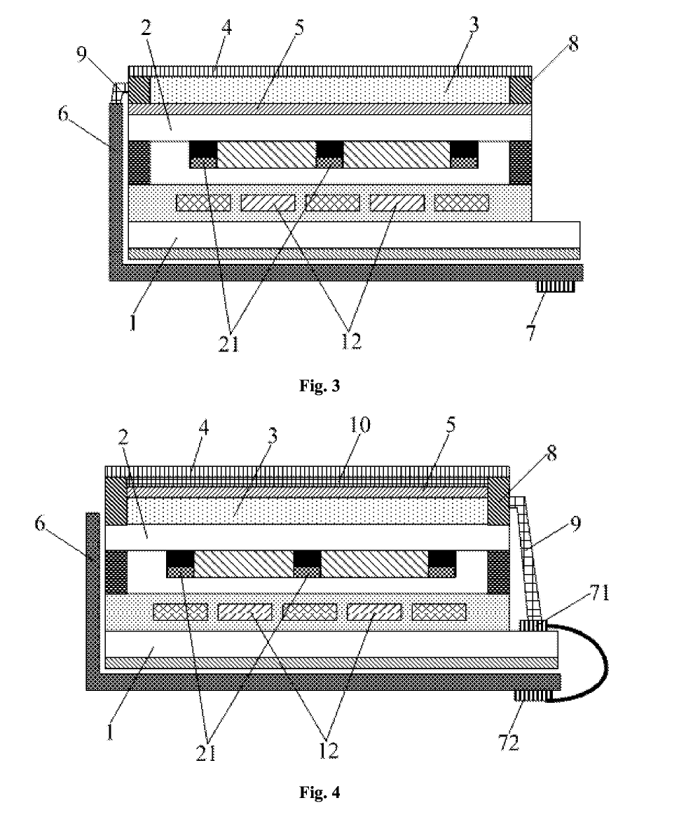

It should be noted that, as shown in FIG. 2, the ground terminal 7 may be provided only on the array substrate 1, the electrostatic releasing layer 3 is connected to the ground terminal 7 through the conductive ink 8, and the conductive ink 8 is connected with the ground terminal 7 through the conductive silver paste 9. When static electricity is accumulated on the electrostatic releasing layer 3, the static electricity can be conducted and released through a path along the electrostatic releasing layer 3, the conductive ink 8, the conductive silver paste 9 and the ground terminal 7. Alternatively, as shown in FIG. 3, the ground terminal 7 may be provided only on the conductive shell 6, in this case, the electrostatic releasing layer 3 may be connected to the conductive shell 6 through the conductive ink 8, and the conductive ink 8 is connected with the conductive shell 6 through the conductive silver paste 9. When static electricity is accumulated on the electrostatic releasing layer 3, the static electricity can be conducted and released through a path along the electrostatic releasing layer 3, the conductive ink 8, the conductive silver paste 9, the conductive shell 6 and the ground terminal 7. The ground terminal 7 is generally connected with a ground line of a periphery circuit so that the static electricity is conducted to ground through the ground line of the periphery circuit.

### Second Embodiment

The present embodiment provides an in-cell touch panel, which is different from that in the first embodiment in that, the electrostatic releasing layer of the touch panel is made of another transparent conductive material with a square resistance of Meg-ohm level or more, for example, transparent conductive material formed by doping PEDOT (Poly(3,4-ethylenedioxythiophene)) in insulation resin material or transparent conductive material formed by doping indium antimony oxide particles in SiO₂ insulation material which is capable of being formed on a substrate by coating, rather than insulation optical adhesive material doped with conductive particles, wherein the PEDOT particles or indium antimony oxide particles are also bonded together by molecules or chemical bonds, so that static electricity accumulated on the electrostatic releasing layer 3 can be conducted out.

In the present embodiment, as shown in FIG. 4, the touch panel further comprises a bonding layer 10, wherein the electrostatic releasing layer 3, the upper polarizer 5 and the bonding layer 10 are successively stacked on the color filter substrate 2, and the cover plate 4 covers the bonding layer 10, wherein the electrostatic releasing layer 3 is directly coated on the color filter substrate 2, and the bonding layer 10 is a non-conductive layer with a bonding effect.

Other structures of the in-cell touch panel in the present embodiment are the same as those in the first embodiment, and will not be repeatedly described here.

### Third Embodiment

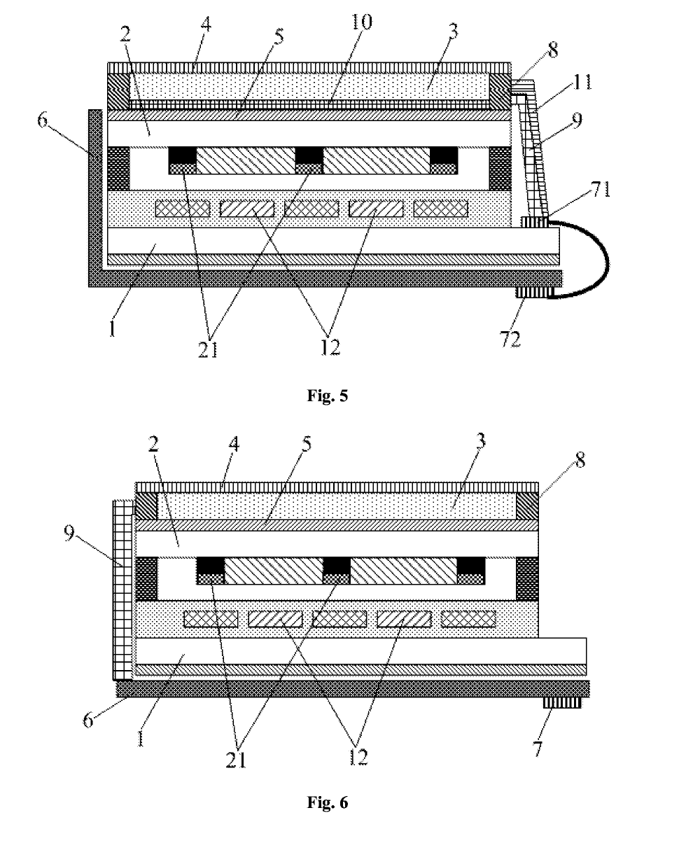

The present embodiment provides an in-cell touch panel, which is different from that in the second embodiment in that, as shown in FIG. 5, in the in-cell touch panel of the present embodiment, the upper polarizer 5, the bonding layer 10 and the electrostatic releasing layer 3 are successively stacked on the color filter substrate 2, and the cover plate 4 covers the electrostatic releasing layer 3, wherein the electrostatic releasing layer 3 is directly coated on the boding layer 10, and the boding layer is a non-conductive layer with a bonding effect.

In addition, in the present embodiment, the first ground terminal 71 is connected with the conductive ink 8 through the conductive silver paste 9 and the conductive adhesive tape 11, the conductive adhesive tape 11 is also provided in the edge region of the in-cell touch panel corresponding to the non-touch-display region. In the present embodiment, the conductive adhesive tape 11 covers the conductive silver paste 9, in such manner, after attaching the cover plate 4 and the color filter substrate 2, the conductive adhesive tape 11 is fully filled in the gap at the position of conductive silver paste 9 between the cover plate 4 and the color filter substrate 2, so that the conductive ink 8 is stably connected with the first ground terminal 71, and the static electricity can be reliably and timely released.

Other structures of the in-cell touch panel in the present embodiment are the same as those in the second embodiment, and will not be repeatedly described here.

### Fourth Embodiment

The present embodiment provides an in-cell touch panel, which is different from that in the first embodiment in that, as shown in FIG. 6, in the present embodiment, the conductive shell 6 is a metal sheet which only covers a side of the touch panel opposite to the touch-display surface (i.e., the back side of the touch panel). In such manner, the thickness of the touch panel may be reduced, so that the cost of the touch panel is reduced.

The conductive ink 8 may be connected with surrounding sides of the conductive shell 6 through the conductive silver paste 9, thus the static electricity on the electrostatic releasing layer 3 may be more uniformly and rapidly released, and poor impact on the touch panel caused by static electricity may be reduced timely.

Other structures of the in-cell touch panel in the present embodiment are the same as those in FIG. 3 in the first embodiment, and will not be repeatedly described here.

In the in-cell touch panels of the first through fourth embodiments, the transparent electrostatic releasing layer with a square resistance above Meg-ohm is provided so that the touch panel is capable of releasing static electricity well without shielding touch signals for the touch panel, thus influence and damage to the touch panel caused by static electricity may be avoided well and touch-display function of the touch panel can be normally achieved.

### Fifth Embodiment

The present embodiment provides a display device comprising the in-cell touch panel in any one of the first through fourth embodiments.

The display device of the present invention may be a device such as a liquid crystal panel, a liquid crystal television, a display, an OLED panel, an OLED television, a phone, a navigator or the like.

By using the in-cell touch panel in any one of the first through fourth embodiments, the display device of the present embodiment can avoid influence and damage caused by static electricity and can normally achieve touch-display function.

It can be understood that, the foregoing implementations are merely exemplary implementations used for explaining the principle of the present invention, but the present invention is not limited thereto. Those of ordinary skill in the art may make various variations and improvements without departing from the spirit and essence of the present invention, and these variations and improvements also fall within the protection scope of the present invention.

1-20. (canceled)

21. An in-cell touch panel, comprising an array substrate and a color filter substrate which are aligned and assembled with each other to form a cell, wherein touch electrodes are provided between the array substrate and the color filter substrate, the in-cell touch panel further comprises an electrostatic releasing layer provided at a side of the color filter substrate away from the array substrate, the electrostatic releasing layer is a transparent conductive layer with a square resistance of Meg-ohm level or more.

22. The in-cell touch panel of claim 21, wherein the square resistance of the electrostatic releasing layer is greater than or equal to 1 MΩ and is less than or equal to 1 kMΩ.

23. The in-cell touch panel of claim 21, further comprises a conductive shell and a ground terminal, the conductive shell covers at least one outer side of the in-cell touch panel except a touch-display surface, the ground terminal is used for connecting static electricity accumulated on the electrostatic releasing layer to ground;
the ground terminal is provided on the array substrate and is electrically connected with the electrostatic releasing layer;
or, the ground terminal is provided on the conductive shell and the electrostatic releasing layer is electrically connected with the conductive shell;
or, the ground terminal includes a first ground terminal and a second ground terminal, the first ground terminal is provided on the array substrate, the second ground terminal is provided on the conductive shell, the first ground terminal is electrically connected with the electrostatic releasing layer, and the first ground terminal is electrically connected with the second ground terminal.

24. The in-cell touch panel of claim 23, further comprises a cover plate and an upper polarizer, the cover plate is used for covering the touch-display surface of the in-cell touch panel;
the upper polarizer is provided at a side of the color filter substrate away from the array substrate.

25. The in-cell touch panel of claim 24, wherein the electrostatic releasing layer is made of insulation optical adhesive material, the insulation optical adhesive material is doped with conductive particles therein, and the conductive particles are uniformly distributed in the insulation optical adhesive.

26. The in-cell touch panel of claim 25, wherein the upper polarizer and the electrostatic releasing layer are successively stacked on the color filter substrate, the cover plate covers the electrostatic releasing layer, and the electrostatic releasing layer also has a bonding effect.

27. The in-cell touch panel of claim 24, further comprises a bonding layer, wherein the electrostatic releasing layer, the upper polarizer and the bonding layer are successively stacked on the color filter substrate, and the cover plate covers the bonding layer.

28. The in-cell touch panel of claim 24, further comprises a bonding layer, wherein the upper polarizer, the bonding layer and the electrostatic releasing layer are successively stacked on the color filter substrate, and the cover plate covers the electrostatic releasing layer.

29. The in-cell touch panel of claim 24, wherein an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

30. The in-cell touch panel of claim 25, wherein an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

31. The in-cell touch panel of claim 26, wherein an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

32. The in-cell touch panel of claim 27, wherein an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

33. The in-cell touch panel of claim 28, wherein an edge region on a side of the cover plate towards the color filter substrate, which corresponds to a non-touch-display region of the in-cell touch panel, is provided with conductive ink therein, the conductive ink is provided in periphery of the electrostatic releasing layer and is connected with the electrostatic releasing layer.

34. The in-cell touch panel of claim 29, wherein the conductive ink has a thickness in a range of 50 μm-100 μm, a width in a range of 0.1 mm-0.5 mm, and a square resistance that is less than or equal to 1 kΩ.

35. The in-cell touch panel of claim 30, wherein the conductive ink has a thickness in a range of 50 μm-100 μm, a width in a range of 0.1 mm-0.5 mm, and a square resistance that is less than or equal to 1 kΩ.

36. The in-cell touch panel of claim 31, wherein the conductive ink has a thickness in a range of 50 μm-100 μm, a width in a range of 0.1 mm-0.5 mm, and a square resistance that is less than or equal to 1 kΩ.

37. The in-cell touch panel of claim 32, wherein the conductive ink has a thickness in a range of 50 μm-100 μm, a width in a range of 0.1 mm-0.5 mm, and a square resistance that is less than or equal to 1 kΩ.

38. The in-cell touch panel of claim 33, wherein the conductive ink has a thickness in a range of 50 μm-100 μm, a width in a range of 0.1 mm-0.5 mm, and a square resistance that is less than or equal to 1 kΩ.

39. The in-cell touch panel of claim 29, wherein, when the ground terminal is provided on the array substrate, the electrostatic releasing layer is electrically connected to the ground terminal through the conductive ink, and the conductive ink is electrically connected to the ground terminal through conductive silver paste and/or conductive adhesive tape;
or, when the ground terminal is provided on the conductive shell, the electrostatic releasing layer is electrically connected to the conductive shell through the conductive ink, and the conductive ink is electrically connected to the ground terminal through conductive silver paste;
or, when the ground terminal includes the first ground terminal and the second ground terminal, the first ground terminal is provided on the array substrate, the second ground terminal is provided on the conductive shell and the first ground terminal is electrically connected with the second ground terminal, the electrostatic releasing layer is electrically connected to the first ground terminal through the conductive ink, and the conductive ink is electrically connected to the first ground terminal through conductive silver paste and/or conductive adhesive tape; wherein,
the conductive silver paste and the conductive adhesive tape are provided in the edge region of the in-cell touch panel corresponding to the non-touch-display region.

40. A display device, comprising the in-cell touch panel of claim 21.
